(19) United States
(12) Patent Application Publication
(10) Pub. No.: US 2006/0095318 A1
(43) Pub. Date: May 4, 2006

(54) System and method of providing discounts on the purchase of gasoline

(76) Inventors: Russell G. Ross, Cranberry Township, PA (US); Rebecca B. Kane, Upper St. Clair, PA (US)

Correspondence Address: ECKERT SEAMANS CHERIN & MELLOTT, 600 GRANT STREET, 44TH FLOOR, PITTSBURGH, PA, 15219, US

(21) Appl. No.: 10/975,277

(22) Filed: Oct. 28, 2004

(51) Int. Cl. G06Q 30/00

(52) U.S. Cl. 705/14

(57) ABSTRACT

A method of providing a customer with a gasoline discount including determining accumulated discount information each time: the customer performs a predefined action, customer identification information is obtained, such as by using a customer identification element, and information relating to the performed action is received. The accumulated discount information is based on the information and is stored in association with the customer identification information. When the customer purchases gasoline, the customer identification information is obtained, the accumulated discount information is obtained using the customer identification information, and the customer may receive a discount based on the accumulated discount information. Also, a discount system includes a retailer POS terminal having a reader device, a main server, a customer database connected to the main server that stores the accumulated discount information, a pump having a reader device, and a gas station computing device connected to the pump and the main server.

### BACKGROUND OF THE INVENTION

1. Field of the Invention

This invention relates to a system and method of providing discounts to customers on the purchase of gasoline, and in particular to a system and method in which customers earn discounts when performing certain actions, such as making purchases, wherein the discounts are associated with customer identification information and may be redeemed by the customers when purchasing gasoline using the customer identification information

2. Description of the Related Art

Many retailers, such as supermarkets, discount stores, warehouse stores or clubs, convenience stores and the like, have programs in which customers are provided with cards, sometimes referred to as frequent shopper cards or loyalty cards, which enable the customers to receive discounts on selected products or other awards if the card is presented (and typically scanned) at the time of purchase. Such cards typically have customer identifying information encoded thereon, such as in the form of an optically readable bar code or some other machine readable form, which link the customer and the card to a particular account and/or record associated with the customer. Many such retailers, in addition to offering their traditional products (e.g. food and household items), also sell gasoline. It would be advantageous for retailers that sell gasoline to be able to provide gasoline discounts to its customers when the customers purchase the retailer's non-gasoline related products and/or utilize or purchase the retailer's non-gasoline related services as an inducement for customers to do so.

One prior art system for providing discounts on the purchase of gasoline based on the purchasing activity of customers is described in U.S. Pat. No. 6,321,984 B1. The disclosed system includes a data processing system that creates and maintains records in a database for customers that make purchases at an associated store. The system tracks the customer purchases and compares them to certain predefined criteria to determine whether the customers are eligible to receive a discount on the purchase of gasoline. The predefined criteria may include the purchase of items from a specified group or the purchase of a specified dollar value threshold of items. When a customer meets one of the predefined criteria, the system authorizes a gasoline discount award and provides the customer with a mechanism for obtaining the discount. The mechanisms that are described include a paper receipt having bar code data that authorizes the discount (that is to be read at the gasoline pump), data authorizing the discount that is magnetically encoded onto a magnetic strip card (that is also to be read at the gasoline pump), and an authorization identification number (that is to be input by the customer, such as on a keypad, at the gasoline pump). The mechanism, in whatever form, notifies a controller located in the gasoline pump that a particular discount should be provided on that particular gasoline purchase. U.S. Pat. No. 6,332,128 describes a similar system in which a gasoline discounts may be encoded in a bar code on a printed receipt, encoded in a radio frequency identification (RFID) device, or magnetically encoded on a frequent shopper card or other magnetic medium such as a prepaid card or credit card. The problem with these systems is that the discount authorizing mechanism itself is provided on an item that is physically possessed/carried by the customer. As such, if lost or damaged, the discount is lost.

U.S. Pat. No. 6,332,128 also describes an embodiment wherein, when a customer makes a purchase that entitles him or her to a gasoline discount, a receipt is printed for the customer that includes, in bar coded form, customer identification and transaction identification information associated with the discount. At the same time, transaction data that includes customer identification information, transaction identification information and information relating to the discount issued during the transaction is stored in a database record. As such, the receipt provided to the customer is linked with the database record, and thus the discount value. When a customer desires to redeem the discount, the customer takes the receipt to the gas station where it is scanned by a bar code reader at the pump. The pump, through a controller with which it is associated, accesses the appropriate customer record from the database, and adjusts the price of the gasoline based on the discount contained in the record. The problem with this approach is that there is a 1:1:1 relationship between the discount earning transaction, the discount that is issued, and the paper receipt provided to the customer such that the customer receives a new receipt each time a discount is earned. The customer must then possess and keep track of multiple receipts in order to get the benefit of each issued discount. To get the benefit of the total of the discounts issued, the customer must scan several receipts, one for each transaction, at the pump. All of this is time consuming and inconvenient for the customer. In addition, keeping track of (and not losing) multiple receipts may be difficult for many customers.

Thus there is a need for a system for enabling customers to earn discounts on the purchase of gasoline when performing certain actions at a retailer location, such as making purchases, wherein the discounts may be redeemed by the customers when purchasing gasoline in which the discount authorizing mechanism itself is not provided on an item that is physically possessed/carried by the customer and in which the customer need not keep track of multiple items relating to a number of discounts earned. Such a system would avoid the problems encountered in the prior art, such as the loss of discounts due to lost or damaged discount authorizing mechanisms and the difficulty and inconvenience of redeeming and keeping track of multiple discount authorizing mechanisms.

### SUMMARY OF THE INVENTION

The present invention, in one embodiment, relates to a method of providing a customer having customer identification information with a discount on the purchase of gasoline including determining accumulated discount information each time: (i) the customer performs one of one or more predefined actions, (ii) the customer identification information is received in association with the one of one or more predefined actions, and (iii) first information relating to the one of the one or more predefined actions is received. The accumulated discount information is based on the first information. The accumulated discount information is stored in a database in association with the customer identification information. The method further includes obtaining the customer identification information when the customer initiates the purchase of gasoline, accessing the stored accumulated discount information from the database using the customer identification information, providing the customer with an ability to elect a discount, if any, based on the accessed accumulated discount information, and providing the customer with an elected discount, if any, on the purchase of gasoline.

The present invention, in another embodiment, relates to a method of providing a customer with a discount on the purchase of gasoline wherein the customer has customer identification information associated with him or her that is used to track and redeem the discounts. The method includes determining accumulated discount information each time: (i) the customer performs one of one or more predefined actions, (ii) the customer identification information is received in association with the performed action, and (iii) first information relating to the performed action is received. The accumulated discount information is determined by converting the first information into a point value, and deriving the accumulated discount information from the point value. The accumulated discount information is stored in association with the customer identification information. The method further includes obtaining the customer identification information when the customer initiates the purchase of gasoline, obtaining the accumulated discount information using the customer identification information, and providing the customer with a discount on the purchase of gasoline based on the accumulated discount information.

In either embodiment, the per-unit price of the gasoline may be adjusted based on the accumulated discount information. Alternatively, a fixed discount amount may be deducted from the total gasoline purchase price on a particular occasion.

According to a preferred embodiment, the customer has or is provided with one or more customer identification elements which have the customer identification information associated therewith. For example, the customer identification element may be a customer card having customer identification information provided thereon in machine readable form, such as bar code form. In this embodiment, the customer allows the customer identification information to be obtained using the customer identification element, for example by reading a customer card, in association with the performed action. In addition, the customer identification information is obtained at the time of the gasoline purchase in this embodiment using the customer identification element.

When the method involves converting the first information into a point value and deriving the accumulated discount information from the point value, the method may also further include storing accumulated points information in association with the customer identification information, and determining new accumulated points information each time the first information is converted into a point value, wherein the new accumulated points information is a sum of the point value and the accumulated points information. Then, the step of deriving the accumulated discount information may include determining a first multiplier by determining the number of times the new accumulated points information is evenly divisible by a predetermined point amount, increasing the accumulated discount information by a first amount equal to the first multiplier multiplied by a predetermined discount amount, and setting the accumulated points information equal to a value obtained by decreasing the new accumulated points information by a second amount equal to the first multiplier multiplied by the predetermined point amount.

In another embodiment, the adjusting step includes determining an available discount amount that is the lesser of the per-unit price and the accumulated discount information, and reducing the per-unit price based on the available discount amount. In addition, the per-unit price may be reduced by the available discount amount. Alternatively, the per-unit price may be reduced by a fractional discount amount from said customer that is a fraction of the available discount amount. The method also preferably includes decreasing the accumulated discount information based on an amount by which the per-unit price was adjusted and storing the decreased accumulated discount information in association with the customer identification information.

The predefined actions performed by the customer to obtain a discount may include, without limitation, one or more of purchasing items from a retail location, purchasing a particular item at the retail location, completing a predetermined event at the retail location, and presenting a discount containing coupon at the retail location. In the case where the predefined action performed by the customer is purchasing a plurality of items from a retail location, the first information may be converted into a point value based on a one point for each dollar of the purchase amount basis. Alternatively, conversions may be based on predetermined fixed point values for each action.

The present invention, in another embodiment, also relates to a system for providing a customer having customer identification information with a discount on the purchase of gasoline. The customer identification information may be associated with one or more customer identification elements such as a customer card having the customer identification information provided thereon in machine readable form, such as bar code form. The system includes a main server and a customer database in electronic communication with the main server. The customer database stores accumulated discount information in association with the customer identification information, wherein the accumulated discount information is determined each time the customer performs one of one or more predefined actions and the customer identification information is obtained in association with the one of one or more predefined actions. The one of one or more predefined actions has first information related thereto, and the accumulated discount information, when determined, is based on the first information. The system also includes a computing device located at a gas station location that is in electronic communication with the main server. The computing device is adapted to access the accumulated discount information from the main server based on the customer identification information when the customer initiates the purchase of gasoline at the gas station location, provide the customer with an ability to elect a discount, if any, based on the accessed accumulated discount information, and provide the customer with an elected discount, if any, on the purchase of

The invention, in yet another embodiment, also relates to a system for providing a customer with a discount on the purchase of gasoline, wherein the customer has customer identification information associated with him or her that is used to track and redeem the discounts. The customer identification information may be associated with one or more customer identification elements such as a customer card having the customer identification information provided thereon in machine readable form, such as bar code form. The system includes a main server and a customer database in electronic communication with the main server. The customer database stores accumulated discount information in association with the customer identification information. The accumulated discount information is determined each time the customer performs one of one or more predefined actions, such as those described above, and the customer identification information is obtained in association with the performed predefined action. The performed predefined action has first information related thereto, and the accumulated discount information, when determined, is based on the first information by converting the first information into a point value and deriving the accumulated discount information from the point value. The system also includes a computing device located at a gas station location that is in electronic communication with the main server. The computing device is adapted to obtain the accumulated discount information from the main server based on the customer identification information and provide the customer with a discount on the purchase of gasoline based on the accumulated discount information.

In either embodiment, the system may include a point-of-sale terminal located at the retailer location for obtaining the customer identification information from one of the customer identification elements, such as by using a reader device. In addition, a gasoline pump at the gas station location may obtain the customer identification information from one of the customer identification elements, such as by using a reader device provided with the gasoline pump.

In addition, the customer database may store accumulated points information in association with the customer identification information, and the retailer computing device may be adapted to determine new accumulated points information each time the first information is converted into a point value. The accumulated discount information in this case is determined, for example by the main server, by: (i) determining a first multiplier by determining the number of times the new accumulated points information is evenly divisible by a predetermined point amount, and (ii) increasing the accumulated discount information by a first amount equal to the first multiplier multiplied by a predetermined discount amount. Also, the accumulated points information is set, for example by the main server, equal to a value obtained by decreasing the new accumulated points information by a second amount equal to the first multiplier multiplied by the predetermined point amount.

The computing device located at the gas station location may be further adapted to determine an available discount amount that is the lesser of the per-unit price and the accumulated discount information, and reduce the per-unit price based on the available discount amount. In particular, the per-unit price may be reduced by the available discount amount, or, alternatively, a fractional discount amount received from the customer. Finally, the point-of-sale terminal may be adapted to provide a discount report, such as on a printed receipt, to the customer that is based on the accumulated discount information.

### BRIEF DESCRIPTION OF THE DRAWINGS

These and other advantages of the present invention will become readily apparent upon consideration of the following detailed description and attached drawings, wherein:

FIG. 1 is a block diagram of a system for providing discounts to customers on the purchase of gasoline according to the present invention;

FIG. 2 is a flowchart of one embodiment of a method of providing discounts on the purchase of gasoline to customers based on certain events occurring at the retailer location shown in FIG. 1 according to the present invention; and

FIGS. 3a and 3b are flowcharts of one embodiment of a method of redeeming discounts on the purchase of gasoline earned according to the method shown in FIG. 2.

### DETAILED DESCRIPTION OF THE PREFERRED EMBODIMENTS

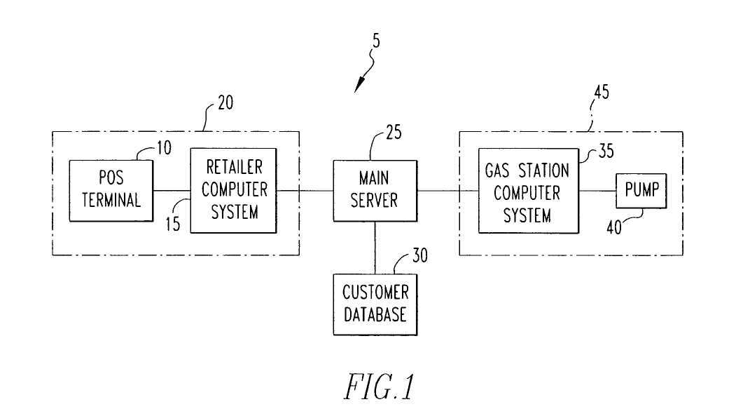

FIG. 1 is a block diagram of a system 5 for providing discounts to customers on the purchase of gasoline using customer identification information associated with the customer according to the present invention. As seen in FIG. 1, system 5 includes point-of-sale (POS) terminal 10 and retailer computer system 15 located at retailer location 20, such as a supermarket, convenience store or the like. Point-of-sale terminal 10 is a computerized device that is, among other things, able to read encoded, machine readable information, such as a bar code (e.g., UPC symbol) or RFID tag, provided on products and other items. In addition, point-of-sale terminal 10 is also able to receive customer identification information, preferably by obtaining the customer identification information from an associated customer identification element as described herein. For example, point-of sale-terminal 10 may be able to read bar coded or other machine-readable customer identification information from a customer card issued to the retailer's customers. Point-of-sale terminal 10 may be a cash register system that is commonly found in supermarkets. Point-of-sale terminal 10 is in electronic communication with retailer computer system 15 to enable information received by point-of-service terminal 10 to be sent to retailer computer system 15. Retailer computer system 15 may be any type of general purpose computing device such as a personal computer (PC), a server computer, or a PC in communication with a server computer. Retailer computer system 15 is provided with software that enables it to process and facilitate purchases being made by the retailer's customers and to perform the steps of the present invention as described herein. A suitable example of such software is the IBM ACE POS system that is customized and configured according to the present invention.

System 5 also includes main server 25, preferably located in a centralized location remote from retailer location 20. Main server 25 is a server computer provided with a software application that enables the retailer to implement a customer loyalty program wherein customers are assigned an account with associated customer identification information for identifying the customer (such as, for example, a unique ID number). Under the program, customers are able to earn rewards and discounts based on purchases or other activities. The software application also enables the retailer to collect important customer related data for use in, for example, marketing efforts. One suitable example of such a software application is the IBM Electronic Marketing Enterprise (EME) Solution. Preferably, although not necessarily, each customer has or is provided with a customer identification element that has the customer identification information for identifying the customer associated therewith, such as information provided thereon in machine readable form like bar code form. Main server 25 is in electronic communication with customer database 30, which stores data relating to the customers of the retailer that is collected by the main server 25, including the discount related information of the present invention that is described herein.

As seen in FIG. 1, system 5 further includes gas station computer system 35 and gasoline pump 40 located at a gas station location 45. Gas station location 45 is preferably a gas station owned and/or operated by the retailer described above. Such a gas station may be located adjacent to retailer location 20 (outside and close to a main store), or may be part of a convenience store owned and/or operated by the retailer. Alternatively, the gas station location 45 may be a remotely located gas station owned and/or operated by the retailer or another entity that is affiliated with the retailer for purposes of the operation of system 5. Gas station computer system 35 may be any type of general purpose computing device such as a PC, a server computer or a PC in communication with a server computer. In addition, gas station computer system 35 is in electronic communication with both main server 25 and gasoline pump 40 to enable data and commands to be exchanged therebetween. Gasoline pump 40 is a conventional gasoline pump that includes a computing device, such as a microprocessor or controller, for controlling the operation thereof. Gasoline pump 40 is adapted to receive customer identification information as described above in connection with the purchase of gasoline. In the preferred embodiment, gasoline pump 40 includes a reading device, such as a known bar code reader, capable of reading customer identification information associated with customer identification elements, such as bar coded customer identification information encoded on a customer card, as described above. Gas station computer system 35 includes software, such as a known POS software system, for processing and facilitating the purchase of gasoline and other items at gas station location 45 that is customized and configured to perform the steps of the present invention as described herein.

Although only a single point-of-sale terminal 10 and a single retailer location 20 are shown in FIG. 1, it will be appreciated that multiple point-of-sale terminals 10 may be connected to retailer computer system 15 and that multiple retailer locations 20 each having a retailer computer system 15 connected to one or more point-of-sale terminals 10 and main server 25 may be provided without departing from the scope of the present invention. As such, a customer may perform discount earning actions at multiple retailer locations 20, with credit for each being stored in customer database 30. Similarly, multiple gas station locations 45 each having a gas station computer system 35 connected to multiple pumps 40 and to main server 25 may be provided without departing from the scope of the present invention so that customers can redeem discounts at multiple locations. Furthermore, as will be appreciated, in certain situations retailer computer system 15 and gas station computer system 35 may be the same device. For example, in the case of a convenience store having a gas station, retailer location 20 and gas station location 45 may be one and the same and retailer computer system 15 and gas station computer 35 may be one and the same, wherein a customer may perform an action at the gas station that results in discounts being earned and then redeem the discount at the pump 40 at the same gas station.

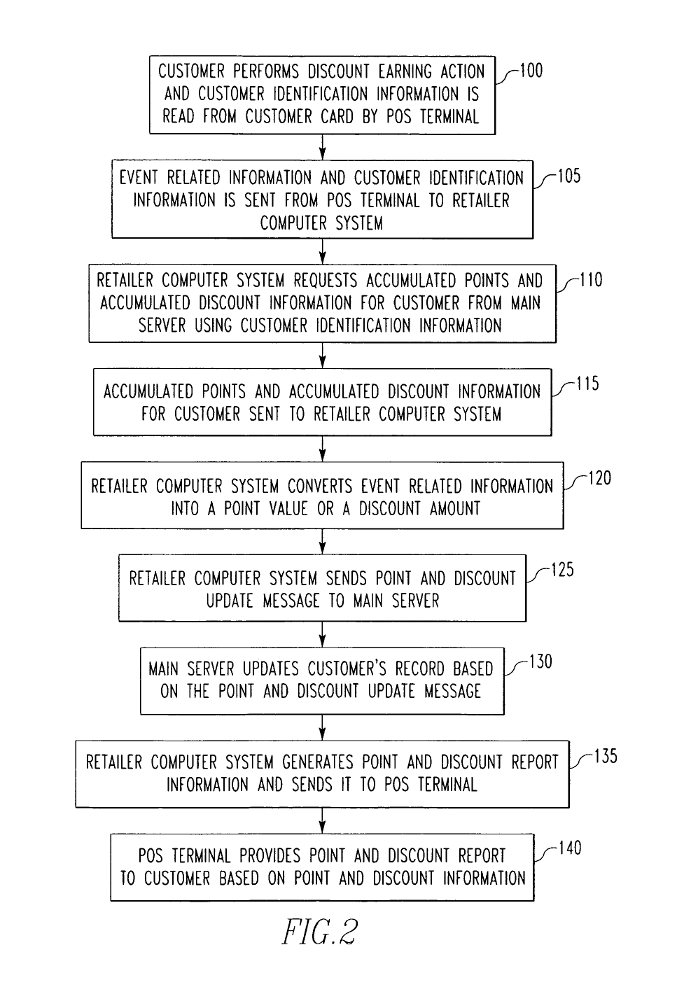

Referring to FIG. 2, a flowchart is provided that illustrates a method according to an aspect of the present invention wherein customers earn discounts on the purchase of gasoline based on certain predefined events or actions taking place at retailer location 20 shown in FIG. 1. As described above, system 5 contemplates that the retailer in question has implemented a program wherein customers may earn discounts and rewards in association with customer identifying information. In the preferred embodiment, each customer has or is provided with one or more customer identification elements that each have customer identification information associated therewith. As used herein, the term customer identification element refers to any device, component, part, piece of information or other means having customer identification information associated therewith that enables the customer to be identified by the retailer in question. Examples of customer identification elements include, without limitation, a customer card having customer identification information provided thereon in bar code or magnetically encoded form, a key fob device, an RFID tag, a credit card or debit card (having the account number linked with the customer identifying information), a phone number, a social security number, a password, or even the customer's fingerprint or retina that may be scanned and read by an appropriate device and matched with an associated customer ID number or the like that is used to identify the customer. In the preferred embodiment of the present invention, the customer identification elements used are customer cards having customer identification information provided thereon. For convenience and ease of description, that type of customer identification element will be used in the following description. However, it will be appreciated that other types of customer identification elements, alone or in combination, may be used and substituted for the customer cards without departing from the scope of the present invention.

The method begins at step 100, where a customer visits retailer location 20 and performs a discount earning action. Discount earning actions may include, without limitation, purchasing items such as groceries (based on, for example, dollar amounts or number of units) from the retailer or an affiliated third party, purchasing particular products or brands from the retailer or an affiliated third party, joining a club or service offered by the retailer, bringing a new prescription to a pharmacy located at the retailer location 20, using a particular bank's debit or credit card for purchases, using the customer's customer card for the first time, presenting a coupon or similar item provided to the customer, such as a coupon indicating that a certain discount will be awarded if the coupon is presented with a purchase using a retailer or affiliated third party service, such as the photo lab, child care or pharmacy, for the first time or a fixed number of times, purchasing from a particular retailer department, such as the bakery or deli, visiting and/or purchasing products or services using the retailer's or affiliated third party's website or answering a retailer survey. In addition, before, during or after the discount earning action, the customer identification information is received by point-of-sale terminal 10. In the preferred embodiment, the customer identification information is read from the customer's customer card that includes a bar code that includes a unique customer identification number. Specifically, this bar code is read by a bar code reader provided as part of point-of-sale terminal 10.

Next, at step 105, certain information relating to the discount earning action, such as the dollar amount of the purchase, the particular item or brand purchased, the number of units of an item or items that are purchased, or the happening of one of the other events described above, and the customer identification information are sent from point-of-sale terminal 10 to retailer computer system 15. Then, at step 110, retailer computer system 15 requests certain information for the customer from main server 25 using the received customer identification information. Specifically, customer database 30 stores for each participating customer, e.g., those having a customer card, a record that includes accumulated points information and accumulated discount information, each of which are described in greater detail below. When requested, that information is retrieved by main server 25 from customer database 30 and is sent to retailer computer system 15 as shown in step 115.

According to the preferred embodiment of the present invention, each of the discount earning actions is converted into either a predetermined number of points or a predetermined discount amount, which points and/or discount amounts may then be used as described herein to determine particular discount levels earned by the customer. Thus, at step 120, retailer computer system 15 converts the event related information received from point-of-sale terminal 10 into either a predetermined point value or a particular predetermined discount amount. For example, it may be predetermined that one point is earned for each dollar spent by the customer on items at retailer location 20, or that a predetermined number of points, such as 20, are earned when a particular item or brand is purchased or when an action such as joining a club, providing a new prescription, or the like has taken place. Alternatively, it may be predetermined that any of these actions may correspond to a particular discount amount rather than a number of points, such as a 10 cent per gallon discount on gasoline. The conversion process may also be dynamic in that different discount levels may be awarded for actions depending on the status of the customer (e.g., customers that purchase in excess of a preset annual amount at the retailer may get larger discounts than other customers). Once the conversion is complete at step 120, retailer computer system 15 sends a point and discount update message to main server 25 as shown at step 125. Based on this message, main server 25 is able to update the accumulated points information and accumulated discount information that is stored in the record associated with the customer in customer database 30 to reflect the recent customer activity. It will be appreciated, however, that this preferred embodiment is only one embodiment of the present invention, and that other methods of determining discount levels based on customer actions may be used.

According to one particular embodiment of the present invention, a customer earns a predetermined discount amount each time a predetermined amount of points is accumulated by the customer as reflected in the accumulated points information stored in customer database 30. That predetermined discount amount, when earned, is added to the accumulated discount information stored in customer database 30. For example, a customer may earn a 10 cent per gallon discount on gasoline each time the number of points accumulated by the customer reaches 50. Once this threshold is reached, the accumulated points information value is returned to zero, and the accumulated discount information value is incremented by the predetermined discount amount (e.g., 10 cents). This particular embodiment may be implemented as follows (although, as will be appreciated, other implementations are possible). First, retailer computer system 15 adds the points earned as determined at step 120 to the accumulated points information value received in step 115 to establish a new accumulated points information value. Retailer computer system 15 then determines how much of the new accumulated points information value is “redeemable” for discount value by determining how many multiples of the predetermined amount of points described above (that must be accumulated to earn a discount) are present in the new accumulated points information value. In other words, a determination is made as to how many times the accumulated points threshold described above may be reached. For example, if the accumulated points information value received at step 115 is 5, and the earned points value as determined at step 120 is 120, and if the predetermined discount amount of 10 cents per gallon is earned every time 50 points is accumulated, retailer computer system 15 will determine that the new accumulated points information value is 125 with 100 points being redeemable. A message to that effect is sent to main server 5 at step 125.

At step 130, main server 5 updates the customer's record in customer database 30 based on the point and discount update message that is received. In particular, main server 5 updates the accumulated points information value and accumulated discount information value stored for that customer in customer database 30 based upon the point and discount update message it has received. In the particular implementation described above, main server 25 will subtract the number of redeemable points from the new accumulated points information value (both as determined by retailer computer system 15) and will store that value as the current accumulated points information value for the customer in customer database 30. Next, main server 25 will take the number of redeemable points and divide that value by the predetermined amount of points required for earning a discount to determine the number of “units” of the predetermined discount amount that the customer has earned. That discount amount is then added to the accumulated discount information value stored for the customer in customer database 30. For example, continuing with the example provided above, if a 10 cent per gallon discount is earned each time the customer accumulates 50 points, then main server 25 will add a 20 cents per gallon discount (100/50×10 cents/gallon) to the accumulated discount information value stored for the customer in customer database 30. Also, the main server 25 will subtract 100 (the redeemable points) from 125 (the new accumulated points information value), and store that value (25) as the current accumulated points information value for the customer.

In the preferred embodiment, the method proceeds to step 135, in which the retailer computer system 15 generates point and discount report information consisting of the currently stored accumulated points information and accumulated discount information values for the customer and sends that information to point-of-sale terminal 10. Next, at step 140, point-of-sale terminal 10 provides a point and discount report to the customer based on the point and discount information received from the retailer computer system 15. The report may be provided, for example, on a printed receipt provided to the customer. The report will preferably include a listing of the customer's current accumulated points information value and the customer's current accumulated discount information value for their reference. At this point, the transaction is complete and the customer may leave retailer location 20.

In another embodiment, customers may be able to access discount related information, such as the customer's current accumulated points information value and the customer's current accumulated discount information value, using a secure (e.g., password protected) internet connection. In this case, the relevant information will be obtained from customer database 30 and presented to the customer through an appropriate website.

In the preferred embodiment shown in FIG. 2, the customer identification information is received and discounts are credited to the customer contemporaneously with the action in question. It will be appreciated, however, that this need not necessarily be the case. As an alternative, the customer identification information may be received by the retailer and discounts may be credited to the customer some time after the action in question has been completed. For example, the retailer could determine that customers will earn discounts by participating in a charity event. After the event, the customer may provide their customer identification number to the retailer, along with proof of participation in the event, and the retailer will credit them with the appropriate discount in customer database 30. Similarly, customers may be able to earn discounts by making purchases through the retailer's or an affiliated third party's website or by making purchases at an affiliated third party retailer, such as a coffee shop or book store. Some time after these events take place, the retailer will credit the customers with the appropriate discounts (based on information relating to the event) in customer database 30. Still other examples may include situations where a customer joins a club or other service offered by the retailer or elects to receive email from the retailer, wherein the customer identification information is provided to the retailer later in time and the retailer later credits them with the appropriate discount. As will be appreciated, the retailer may accomplish this (actually crediting the customer subsequent to a discount earning action or event) using a computer system (not shown) that has access to customer database 30 through main server 25 or that is directly connected to customer database 30.

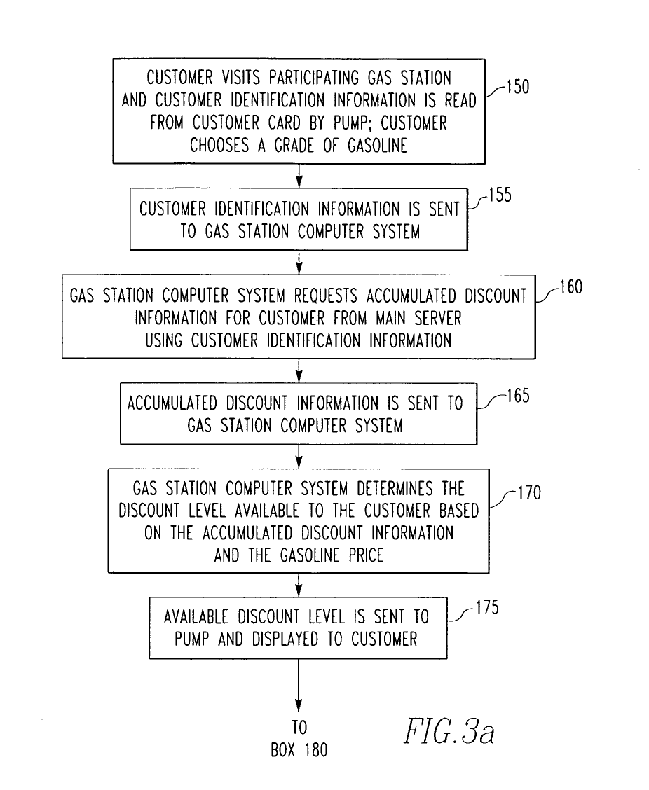

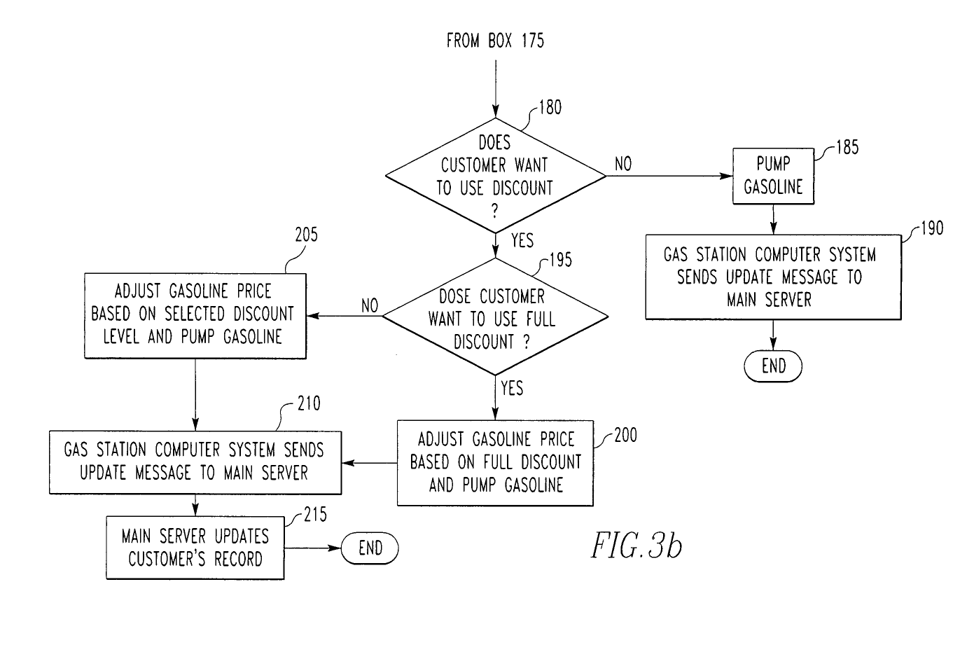

Referring to FIGS. 3a and 3b, a flowchart is provided that illustrates a preferred embodiment of a method according to an aspect of the present invention wherein customers are able to redeem discounts on the purchase of gasoline that were earned in the manner described in connection with FIG. 2. The method begins at step 150, where a customer that has earned gasoline discounts visits a participating gas station, such as gas station location 45 shown in FIG. 1 (as described above, retailer location 20 and gas station location 45 may actually be one and the same). In the preferred embodiment, the customer utilizes the reader provided on pump 40 to read the customer identification information from the customer's customer card (or some other customer identification element). The customer card, in this preferred embodiment, includes a bar code containing this information, and the customer swipes the bar code past the bar code reader provided on pump 40. The customer then chooses a grade of gasoline that he or she wishes to purchase. Next, at step 155, the customer identification information is sent to the gas station computer system 35 by pump 40. At step 160, the gas station computer system 35 then requests the accumulated discount information for the particular customer from main server 25 using the customer identification information that was read by pump 40. In response to this request, the main server accesses the accumulated discount information from customer database 30 and, at step 165, sends the accumulated discount information to gas station computer system 35. It will be appreciated that other methods of obtaining the customer identification information at gas station location 45 are possible. For example, pump 40 may obtain debit card information from the customer, which is used to obtain the customer identification information and ultimately the associated customer identification information.

As described above, the accumulated discount information will preferably be a particular total price per gallon discount that has been earned and accumulated by the customer. The discount information could also include fixed dollar amounts to be deducted from a particular purchase. At step 170, gas station computer system 35 determines the discount level that is available to the customer for use in the current transaction based on the accumulated discount information received from main server 25 and the gasoline price for the grade of gasoline chosen by the customer. In particular, in the preferred embodiment, the maximum discount level that will be available to a customer is the current price per gallon of the grade of gasoline chosen by the customer. In other words, the current price per gallon of gasoline is preferably, although not necessarily, the upper limit of the discount that is available, in which case the customer will be able to purchase a predetermined amount of gasoline at no charge. Thus, the available discount will preferably be the lesser of the price per gallon of the gasoline and the accumulated discount information value. If the accumulated discount information represents a price per gallon discount that is greater than the price per gallon of the gasoline chosen by the customer, the excess amount, in the preferred embodiment, will be saved by system 5 for future use by the customer.

Next, the available discount level determined in step 170 is, at step 175, sent to pump 40 and is displayed to the customer on a display provided on pump 40. At step 180, a determination is then made as to whether the customer wants to use the available discount on the current transaction. If the customer chooses not to use the available discount, such as by providing an indication to that effect on a keyboard or the like provided on pump 40, then, at step 185, the customer pumps the desired amount of gasoline at the current, non-discounted price. As seen at step 190, gas station computer system 35 then sends an update message to main server 25 which, in this case, will indicate that the customer has not used any of the accumulated discount information value. In response, of main server 25 will not make any changes to the customer's record stored in customer database 30.

If, however, the answer at step 180 is yes (the customer wants to use a discount), a determination is made at step 195, again using a display and a keyboard or the like provided on pump 40, as to whether the customer wants to use the full discount that is available, or, alternatively, some fraction of the full discount that is available. If the customer chooses to use the full discount, then, at step 195, the price of the grade of gasoline chosen by the customer is adjusted based upon the full discount amount, and the customer then pumps the desired amount of gasoline, preferably up to some predetermined volume limit amount (e.g. a maximum number of gallons), using pump 40. For example, if the price per gallon was $1.90 and the available discount was 50 cents per gallon, the price of the gasoline would be adjusted to $1.40 per gallon. If, however, the answer at step 195 is no, meaning that the customer only wishes to use a fraction of the available discount, the customer enters the desired discount amount using a keyboard or the like provided on pump 40 and, at step 205, the pump 40 adjusts the price per gallon of the gasoline based upon the selected discount level. The customer then pumps the desired amount of gasoline, again up to a predetermined volume limit in the preferred embodiment, using pump 40. For example, if the price per gallon of gasoline is $1.90, and the customer has an available discount of 50 cents per gallon, yet chooses to use only 20 cents per gallon, the price per gallon of the gasoline would be adjusted to $1.70.

Following either step 200 or 205, whichever is appropriate in the current situation, the gas station computer system 35 sends an update message to main server 25 indicating the amount of discount that has been used at step 210. In particular, gas station computer system 35 will send a message that indicates either that the full available discount amount has been used or, if appropriate, the particular fraction of the full available discount that has been used. Next, at step 215, the main server 25 updates the customer's record in customer database 30 to reflect that a discount has been used. In particular, the accumulated discount information value stored in customer database 30 for the customer will be decreased in an amount equal to the discount that was used by the customer in the particular transaction (either the full available discount as determined at step 125, or some fraction thereof specified by the customer). For example, if the accumulated discount value stored in customer database 30 prior to step 150 was 50 cents per gallon, and the customer chose to utilize a 20 cent per gallon discount, the available discount information value stored in customer database 30 would be decreased from 50 cents per gallon to 30 cents per gallon, meaning that a 30 cent discount would be available for the customer for use in future transactions.

Thus, the present invention provides a system and method for enabling customers to earn discounts on the purchase of gasoline when performing certain actions at a retailer location, such as making purchases, which avoids problems such as the loss of discounts due to lost or damaged discount authorizing mechanisms and the difficulty and inconvenience of redeeming and keeping track of multiple discount authorizing mechanisms. The present invention does so by storing discount related information at a central location and enabling the discounts to be redeemed by the customers when purchasing gasoline using the customer's customer identification information. As such, the discount authorizing mechanism itself is not provided on an item that is physically possessed/carried by the customer and the customer need not keep track of multiple items relating to multiple discounts that are earned. In addition, from a retailer perspective, the present invention allows retailers to better track and manage total discount amounts that are outstanding, enables retailers to provide better customer service as each customer's discount data is contained in a central location, and enables retailers to target market products based on the fuel related purchasing activities of customers.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A method of providing a customer with a discount on the purchase of gasoline, said customer having customer identification information, the method comprising:
determining accumulated discount information each time: (i) said customer performs one of one or more predefined actions, (ii) said customer identification information is received in association with said one of one or more predefined actions, and (iii) first information relating to said one of one or more predefined actions is received, said accumulated discount information being based on said first information;
storing in a database said accumulated discount information in association with said customer identification information;
obtaining said customer identification information when said customer initiates the purchase of gasoline;
accessing said stored accumulated discount information from said database using said customer identification information;
providing said customer with an ability to elect a discount, if any, based on said accessed accumulated discount information; and
providing said customer with an elected discount, if any, on said purchase of gasoline.

2. The method according to claim 1, said customer having one or more customer identification elements each having said customer identification information associated therewith, wherein said customer identification information is received in association with said one of one or more predefined actions as a result of said customer allowing said customer identification information to be obtained using one of said one or more customer identification elements, and wherein said customer identification information is obtained when said customer initiates the purchase of gasoline using one of said one or more customer identification elements.

3. The method according to claim 2, said one or more customer identification elements being a customer card, said customer identification information being provided on said customer card in bar code form, said customer identification information being obtained by reading said customer identification information from said customer card.

4. The method according to claim 1, said gasoline having a per-unit price, said step of providing said customer with an elected discount, if any, comprising adjusting said per-unit price based on said elected discount, if any.

5. The method according to claim 1, said determining step comprising converting said first information into a point value, and deriving said accumulated discount information from said point value.

6. The method according to claim 5, further comprising:
storing accumulated points information in association with said customer identification information; and
determining new accumulated points information each time said first information is converted into a point value, said new accumulated points information being a sum of said point value and said accumulated points information;
wherein said step of deriving said accumulated discount information comprises:
(i) determining a first multiplier by determining the number of times said new accumulated points information is evenly divisible by a predetermined point amount;
(ii) increasing said accumulated discount information by a first amount equal to said first multiplier multiplied by a predetermined discount amount; and
(iii) setting said accumulated points information equal to a value obtained by decreasing said new accumulated points information by a second amount equal to said first multiplier multiplied by said predetermined point amount.

7. The method according to claim 4, further comprising determining an available discount amount, said available discount amount being the lesser of said per-unit price and said accumulated discount information, wherein said elected discount is based on said available discount amount.

8. The method according to claim 7, wherein said elected discount, if any, equals said available discount amount.

9. The method according to claim 7, further comprising receiving a fractional discount amount from said customer, said fractional discount amount being a fraction of said available discount amount, wherein said elected discount, if any, equals said fractional discount amount.

10. The method according to claim 9, further comprising decreasing said accumulated discount information by said fractional discount amount after said adjusting step and storing said decreased accumulated discount information in said database in association with said customer identification information.

11. The method according to claim 8, further comprising decreasing said accumulated discount information by said available discount amount after said adjusting step and storing said decreased accumulated discount information in said database in association with said customer identification information.

12. The method according to claim 4, further comprising decreasing said accumulated discount information based on an amount by which said per-unit price is adjusted after said adjusting step and storing said decreased accumulated discount information in said database in association with said customer identification information.

13. The method according to claim 1, said determining step comprising converting said first information into one of a point value and a discount amount, and deriving said accumulated discount information based on said one of a point value and a discount amount.

14. The method according to claim 1, further comprising providing a discount report to said customer after said storing step, said discount report being based on said accumulated discount information.

15. The method according to claim 14, wherein said discount report is provided on a receipt.

16. The method according to claim 1, said one or more predefined actions being one or more of purchasing one or more items from a retail location or website, purchasing a particular item at said retail location or website, completing a predetermined event at said retail location, and presenting a discount containing coupon at said retail location.

17. The method according to claim 16, wherein when said one of said one or more predefined actions performed by said customer is purchasing one or more items from a retail location or website, said one or more items having a purchase amount, said first information comprises said purchase amount and said first information is converted into said point value based on a one point for each dollar of said purchase amount basis.

18. The method according to claim 16, wherein when said one of said one or more predefined actions performed by said customer is purchasing a particular item or brand from a retail location or website, said first information comprises an identification of said particular item or brand and said point value is a corresponding predetermined point value.

19. The method according to claim 16, wherein when said one of said one or more predefined actions performed by said customer is completing a particular predetermined event at a retail location, said first information comprises an identification of said particular predetermined event and said point value is a corresponding predetermined point value.

20. The method according to claim 13, wherein when said one of said one or more predefined actions performed by said customer is presenting a discount containing coupon at a retail location, said first information comprises discount information from said coupon and said discount amount is based on said discount information.

21. The method according to claim 2, said one or more customer identification elements being selected from the group consisting of a customer card, a key fob device, an RFID tag, a credit card, a debit card, a phone number, a social security number, a password, the customer's fingerprint, and the customer's retina.

22. A system for providing a customer with a discount on the purchase of gasoline, said customer having customer identification information, comprising:
a main server;
a customer database in electronic communication with said main server, said customer database storing accumulated discount information in association with said customer identification information, said accumulated discount information being determined each time said customer performs one of one or more predefined actions and said customer identification information is obtained in association with said one of one or more predefined actions, said one of one or more predefined actions having first information related thereto, said accumulated discount information, when determined, being based on said first information;
a computing device located at a gas station location, said computing device being in electronic communication with said main server, said computing device being adapted to access said accumulated discount information from said main server based on said customer identification information when said customer initiates the purchase of gasoline at said gas station location, provide said customer with an ability to elect a discount, if any, based on said accessed accumulated discount information, and provide said customer with an elected discount, if any, on said purchase of gasoline.

23. The system according to claim 22, further comprising a point-of-sale terminal located at a retailer location and a gasoline pump located at said gas station location that is in electronic communication with said computing device located at said gas station location, said customer having one or more customer identification elements each having said customer identification information associated therewith, said point-of-sale terminal having a first reader device for reading one or more of said one or more customer identification elements, said gasoline pump having a second reader device for reading one or more of said one or more customer identification elements, wherein said customer identification information is obtained in association with said one of one or more predefined actions by reading one of said one or more customer identification elements using said first reader device, wherein said customer identification information is obtained when said customer initiates the purchase of gasoline at said gas station location by reading one of said one or more customer identification elements using said second reader device, and wherein said customer identification information is sent to said computing device located at said gas station location.

24. The system according to claim 23, said one or more customer identification elements being a customer card, said customer identification information being provided on said customer card in bar code form, said first and second reader devices each comprising a bar code reader.

25. The system according to claim 22, said gasoline having a per-unit price, said computing device being further adapted to adjust said per-unit price based on said elected discount, if any.

26. The system according to claim 22, further comprising a retailer computing device in electronic communication with said main server, said retailer computing device receiving said first information and converting said first information into a point value when said customer performs said one of one or more predefined actions and said customer identification is obtained in association with said one of one or more predefined actions, said accumulated discount information, when determined, being based on said point value.

27. The system according to claim 26, said customer database storing accumulated points information in association with said customer identification information, said retailer computing device being adapted to determine new accumulated points information each time said first information is converted into a point value, said new accumulated points information being a sum of said point value and said accumulated points information, wherein said accumulated discount information is determined by: (i) determining a first multiplier by determining the number of times said new accumulated points information is evenly divisible by a predetermined point amount, and (ii) increasing said accumulated discount information by a first amount equal to said first multiplier multiplied by a predetermined discount amount, and wherein said accumulated points information is set equal to a value obtained by decreasing said new accumulated points information by a second amount equal to said first multiplier multiplied by said predetermined point amount.

28. The system according to claim 27, said accumulated discount information being determined by said main server and said accumulated points information being set by said main server.

29. The system according to claim 25, said computing device located at said gas station location being further adapted to determine an available discount amount, said available discount amount being the lesser of said per-unit price and said accumulated discount information, wherein said elected discount, if any, is based on said available discount amount.

30. The system according to claim 29, wherein said elected discount, if any, is equal to said available discount amount.

31. The system according to claim 29, said computing device located at said gas station location being further adapted to receive a fractional discount amount from said customer, said fractional discount amount being a fraction of said available discount amount, wherein said wherein said elected discount, if any, is equal to said fractional discount amount.

32. The system according to claim 24, wherein said main server is adapted to decrease said accumulated discount information based on an amount by which said per-unit price is adjusted by said computing device located at said gas station location, said decreased accumulated discount information being stored by said customer database in association with said customer identification information.

33. The system according to claim 22, further comprising a retailer computing device in electronic communication with said main server, said retailer computing device receiving said first information and converting said first information into one of a point value and a discount amount when said customer performs said one of one or more predefined actions and said customer identification element is obtained in association with said one of one or more predefined actions, said accumulated discount information being based on said one of a point value and a discount amount.

34. The system according to claim 23, said point-of-sale terminal being adapted to provide a discount report to said customer, said discount report being based on said accumulated discount information.

35. The system according to claim 34, said discount report being a receipt printed by said point-of-sale terminal.

36. The system according to claim 23, said one or more customer identification elements being selected from the group consisting of a customer card, a key fob device, an RFID tag, a credit card, a debit card, the customer's fingerprint, and the customer's retina.

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)
